(19) United States
(12) Patent Application Publication
(10) Pub. No.: US 2023/0329194 A1
(43) Pub. Date: Oct. 19, 2023

(54) ANIMAL WASTE COLLECTION DEVICE

(71) Applicant: Geoffrey Rendell Vacca, Okotoks (CA)

(72) Inventor: Geoffrey Rendell Vacca, Okotoks (CA)

(21) Appl. No.: 17/719,624

(22) Filed: Apr. 13, 2022

(51) Int. Cl. A01K 23/00; E01H 1/12

(52) U.S. Cl. CPC A01K 23/005; E01H 1/1206; E01H 2001/1293

(57) ABSTRACT

An animal waste collection device comprising a handle attached at first end of a shaft and a collection member at a second end of the shaft. The collection member comprises a shovel head having two hooks at the rear of the shovel as well as another hook positioned on the shaft. At the rear of the shovel there is a waste container, such as a collection bag. The pet waste is collected on the head of the shovel, the shovel is then rotated vertically such that the waste slides off the rear of the shovel into the waste container such that the user is able to collect and package the waste from a standing position without having to touch the waste directly. When the waste container is full the user rotates the device, unhooks the waste container from the collection member and shovel head and disposes of it.

### FIELD OF THE INVENTION

The present disclosure relates to a device to aid in the collection of animal waste, more specifically, but not by way of limitation to a pet waste scoop or shovel, more particularly to a scoop or shovel having a long handle and a detachable bag allowing for ease of disposal.

### BACKGROUND

Any discussion of the related art throughout the specification should in no way be considered as an admission that such related art is widely known or forms part of common general knowledge in the field.

U.S. Pat. No. 11,096,377 (Rogers) discloses an adjustable pet waste scoop. The pet waste scoop includes a handle shaft and a scoop shaft connected in a telescopic configuration, such that the overall length of the device is adjustable. A scoop is connected to a lower end of the scoop shaft. The scoop includes an open-ended front portion extending in a first direction perpendicular to the scoop shaft and an open-ended rear portion extending in an opposing second direction at an upward angle with respect to the front portion. The scoop may include one or more clips for securing a pet waste bag to the scoop and may further include annular grooves that receive clamps or other fasteners for further securing the pet waste bag. The open-ended configuration and fasteners allow a pet waste bag to be attached to the scoop in multiple configurations according to user preference.

DE Pub. No. 10/2012,103071 (Gleich) discloses a dog excrement collector having a tubular container with plastic bags mounted on handle of bar and provided with longitudinal opening. The dog excrement collector is formed by a rod with a corresponding handle and ends at the lower part in a tip made of rubber or plastic, wherein the body of the rod consists of two tubes, the two telescopic form contiguous sections, and has slightly above the top a rectangular frame to collect the excrement of the dog, around the ring around the opening of a plastic bag is attached and the telescopic rod at the end a small shovel, which is practicably foldable by a hinge. A tubular container with plastic bags attached to the handle of the rod has a longitudinal opening through which the bags can be removed as needed like a tissue box or paper towel box.

U.S. Pat. No. 8,641,109 (Ng) discloses a pet shovel. A pet shovel has an elongated handle, a shovel head and a bag mounting frame disposed between the shovel head and a distal end of the elongated handle. The frame forms an opening between the shovel head and the distal end of the elongated handle. The bag mounting frame is adapted to retain a mouth of a bag open disposed between the shovel head and the distal end of the elongated handle in the opening between the shovel head and the distal end of the elongated handle. A bag body support extends from a bottom of the elongated handle to receive a body of the bag mounted on the bag mounting frame to form a sump in an end of the bag, distal from the shovel head and the mouth of the bag.

U.S. Pat. No. 10,352,009 (Cook) discloses an animal feces collection assembly. The collection assembly includes a collection unit that may be positioned on the ground in front of animal feces. A bag is removably positioned on the collection unit for receiving the animal feces. A scooper is provided for urging the animal feces into the collection unit. The animal feces may be dog feces or feces from another domesticated animal. The collection unit comprises a shaft that has a first end and the shaft is threaded adjacent to the first end. A frame is included and the frame has a pair of first members extending between and being oriented perpendicular to a pair of second members. The first members are spaced apart from each other such that the frame has a rectangular shape. The frame 22 has an outwardly facing surface and a rearwardly facing surface.

U.S. Pub. No. 2005/018,454 (Graziosi) discloses a dispose a poop. A light weight, easy to use waste scooper with a unique disposable bag. The disposable bag is simply released into the trash by a handle on the scooper. The disposable bags are easily attached onto the scooper. The first method is used to scoop up waste that is already on the ground. While holding the main frame one slides the front of the scooper blade under the waste to scoop the waste allowing the waste to slide on top of the scooper blade. Next while still holding the main frame tilt the scooper so that the scooper blade is perpendicular to the ground. This will allow the waste to slide along disposable bag guide and into the disposable bag. While holding the scooper in this position over a trashcan, the release handle is squeezed which collapses the bag holder and allows the disposable bag to fall on its own.

U.S. Pat. No. 8,684,429 (Holub) discloses a debris collection and disposal tool. A portable waste disposal tool uses recycled plastic merchandise bags secured to a frame by an adjustable tensioning bag clamp and sliding lock assembly, including a sliding lock and a bag clamp, the frame holding the bag in an open position to contain debris from an indoor or outdoor hard surface, a yard or other ground surface, including dirt, dust, yard waste and pet waste. The frame is attached to the lower end of an elongated extension handle wherein the waste is maintained within the plastic bag until deposited in a trash receptacle by a simple single-handed release of the bag clamp.

U.S. Pub. No. 2014/032,7256 (Zurn) discloses a waste retrieval device. The invention takes the form of a waste retrieval device in the form of an elongate scoop having front and back openings, with a handle attached to the scoop and a bag attachment device connected to the scoop for removably fastening a bag to the scoop, so that the opening of the bag completely encloses the back opening of the scoop, such that waste can be easily scooped up and transferred to the bag, which can be removed from the scoop and disposed of.

U.S. Pat. No. 7,040,677 (Wickser) discloses a retrieval and collection device. A device for retrieving and disposing of solid or semi-solid waste such as dog waste comprising an elongated handle and a hinged bag supporting frame that is operated by a mechanism in the handle. A bag can be inserted over the two halves of the bag-supporting frame creating a cavity or depression, which will cause the waste to be trapped in the cavity or depression when the frame pivots to a closed position, after which the bag can be removed inside-out.

U.S. Pub. No. 2015/002,1943 (Montgomery) discloses a pick-up tool for pet waste or the like. An extended pickup tool adapted to pick up pet waste or the like from a surface from a standing, upright position. The pickup tool consists of an elongated body having a trigger mechanism disposed in a handle at an upper end thereof. A pair of pickup assemblies, each having a pair of orthogonal surfaces is pivotally attached to the lower end of the elongated handle. A coupling mechanism connected to both the trigger mechanism and the pair of opposing, pivotally connected pickup elements causes the pickup elements to move towards one another. When the pair of pickup assemblies is fully closed, lower surfaces of their respective orthogonal surfaces overlap one another. A plastic bag may be positioned over the pair of pickup assemblies. When in a proper position, the pickup elements are brought together and into an overlapping relationship capturing the waste in a portion of the plastic bag.

U.S. Pat. No. 6,641,188 (Arceo) discloses an animal waste scooper. An animal waste scooper device comprising a hand grip on one end of a shaft having a scoop with an openable door and a removable bag at the opposite end. The hand grip operates the opening of the door for scooping up the animal waste into the bag. The invention is a pet litter removal device which enables the user to scoop up pet litter into an attached bag without the strain of bending over in the process. The device enables a pet owner to clean up the solid animal waste of the pet deposited on the lawn without bending over and with a minimum of effort to pass the waste into a paper or plastic collection bag tied to the plastic scooper body of the animal waste scooper device.

U.S. Des No. 917,113 (O′Neill) illustrates a pet waste scooping apparatus. The pet waste scooping apparatus with a detachable scooper and a bag received within the front of the pet waste scooping apparatus.

U.S. Pat. No. 9,828,175 (Zugel) discloses an apparatus used with a sleeve receptacle to make an animal waste bag holder apparatus or with a trash can receptacle to allow air captured between the bag and the trash can to escape. The apparatus includes a bolt that extends through a side hole formed on the receptacle. The bolt’s head is placed adjacent to the inside surface of the receptacle and the threaded shaft extends through the side hole. When a plastic bag is inserted into the receptacle, the bag’s top edge is folded over the outside surface of the receptacle and placed below or adjacent to the side hole. The holder includes a flange nut with internal threads which when tightened on the shaft, presses against the portion of the plastic bag adjacent to the side hole. When tightened, the portion of the plastic bag is pulled which tightens the plastic bag around the receptacle.

All documents cited herein are incorporated by reference.

It is clear that there exists a need for an animal waste collection device having a simple design, that is easy to use, that provides a sanitary method for waste pick up and does not require the user to bend down or stoop to collect the waste. There is a need for a device, with no moving parts, that has easy bag removal and replacement, that holds large amount of waste, that can clean up multiple piles of waste in short time be easy to clean if necessary.

### BRIEF SUMMARY

It is an object of the invention to provide an animal waste collection device.

In accordance with an aspect of the invention, there is provided an animal waste collection device comprising: a planar shovel member extending towards a front side of the device, the shovel member having a front edge, a rear edge and two opposing sides; a tubular connector having a lower end and an upper end; a connector assembly comprising a fork connector having opposing pronged ends and a central portion, the opposing pronged ends attached to the rear edge or the two opposing sides of the shovel member, the central portion being attached to the lower end of the tubular connector; a waste funnel section formed between the rear edge of the shovel member and the fork connector; three or more points of attachment situated at three or more positions around the waste funnel section on a rear side of the device, wherein a waste collection container is attached to the device via the three or more points of attachment.

### BRIEF DESCRIPTION OF THE DRAWINGS

To easily identify the discussion of any particular element or act, the most significant digit or digits in a reference number refer to the figure number in which that element is first introduced.

In the figures, embodiments are illustrated by way of example. It is to be expressly understood that the description and figures are only for the purpose of illustration and as an aid to understanding.

Embodiments will now be described, by way of example only, with reference to the attached figures.

FIG. 1 illustrates a rear perspective view 100 of the device in accordance with one embodiment of the invention.

FIG. 2 illustrates a front view 200 of the device in accordance with one embodiment of the invention.

FIG. 3 illustrates a side view 300 of the device in accordance with one embodiment of the invention.

FIG. 4 illustrates a side perspective view 400 of the device in accordance with one embodiment of the invention.

FIG. 5 illustrates a rear perspective view with collection bag attached 500 in accordance with one embodiment of the invention.

FIG. 6 illustrates a front view with collection bag attached 600 in accordance with one embodiment of the invention.

FIG. 7 illustrates a front perspective view with collection bag attached 700 in accordance with one embodiment of the invention.

FIG. 8 illustrates an elevated side perspective view with collection bag attached 800 in accordance with one embodiment of the invention.

FIG. 9 illustrates a perspective view of the head portion 104 of the device in accordance with one embodiment if the invention.

FIGS. 10A and B illustrates rear perspective views of a head portion 104 of the device in accordance with one embodiment of the invention.

FIGS. 11A and B illustrate top and front perspective views of the device in accordance with one embodiment of the invention.

FIGS. 12A and B illustrate side and reap respective views the subject matter in accordance with one embodiment of the invention.

### DETAILED DESCRIPTION

The details of one or more embodiments of the subject matter of this specification are set forth in the accompanying drawings and the description below. Other features, aspects, and advantages of the subject matter will become apparent from the description, the drawings, and the claims.

Like reference numbers and designations in the various drawings indicate like elements.

The embodiments of the invention described and claimed herein relate to a pet waste scoop/shovel with long handle and detachable bag. In one embodiment the device employs plastic grocery bags and has the shovel head at a 125-degree angle from the shaft of the device.

The device functions by easily scooping up pet waste. It has no moving parts and easily dumps waste into a containment bag. The connection fittings may be adjustable and may comprise a multiple hook system for attachment of the containment bag. These fittings are configured to allow easy bag replacement and disposal.

In some embodiments of the invention, the handle is retractable, extendable or has a telescopic shaft. The shape and angle of the scoop or shovel may be various different sizes shapes and dimensions. In some embodiments, it may be funnel shaped.

The device is functional all year round and is excellent for use in sub-zero winter temperatures. Dog excrement can easily be broken up with the shovel, then lifted and dropped into the containment bag.

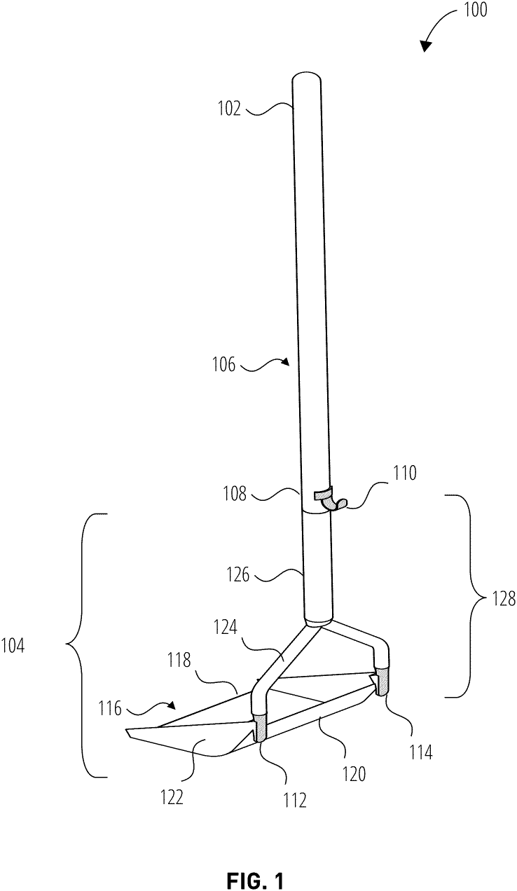

FIG. 1 illustrates a rear perspective view 100 of an animal feces collection device according to one embodiment of the invention.

In one embodiment of the invention, the shaft 106 of the device has an upper end 102 and a lower end 108. Typically, embodiments of the invention have a shaft 106 with a circular cross-section.

The shovel 116 portion of one embodiment of the invention comprises an essentially planar member, typically having a square or rectangular configuration. The shovel 116 having a front edge 118, a rear edge 120 and two opposing sides 122.

A connector assembly 128 connects the shovel 116 to the lower end 108 of the shaft 106. In embodiments of the invention having a shaft 106 with a circular cross-section (as illustrated) the lower end 108 of the shaft 106 typically fits into a tubular connector 126. The connector assembly 128 further comprises a means of attaching to the shovel 116. In the illustrated embodiment a fork connector 124 is configured to be attached to the tubular connector 126 at one end and the shovel 116 at the other end

The head portion 104 of the device comprises the shovel 116 and the connector assembly 128. The connector assembly 128 is used to position the shovel 116 portion to extend in a forward-facing orientation.

One or more first hooks 110, or points of attachment, are situated on the lower end 108 of the shaft 106. The one or more first hooks 110, or points of attachment, are positioned in a rear facing orientation.

In an alternative embodiment of the invention the one or more first hooks 110, or points of attachment, can be situated on the rear side of the tubular connector 126.

In yet another embodiment of the invention one or more first hooks 110, or points of attachment, can be situated on the lower end 108 of the shaft 106 and one or more first hooks 110, or points of attachment, can be situated on the tubular connector 126.

In an additional embodiment, the first point of attachment may be moveable to various positions on the lower end 108 of the shaft 106, or along the connector assembly 128.

A second hook 112, or point of attachment, is positioned on or at the end of one of the prongs of the fork connector 124 and a third hook 114, or point of attachment, is positioned on or at the end of the other prong of the fork connector 124.

In some embodiments of the invention, the second hook 112 and third hook 114, or points of attachment, are an integral or unitary part of the fork connector 124. In some embodiments of the invention, the one or more first hooks 110, or points of attachment, are an integral or unitary part of the connector assembly, illustrated herein as a tubular connector 126.

Alternatively, the first hook 110, second hook 112, third hook 114 (or points of attachment), shovel 116 and connector assembly form a unitary structure. The connector assembly that attaches the head portion 104 to the lower end 108 of the shaft 106 may include, but is not limited to, a tubular connector 126 and fork connector 124. In some embodiments, the fork connector 124 may be a semi-circular structure.

A container or bag (not shown) is selected to be attached to the hooks or points of attachment.

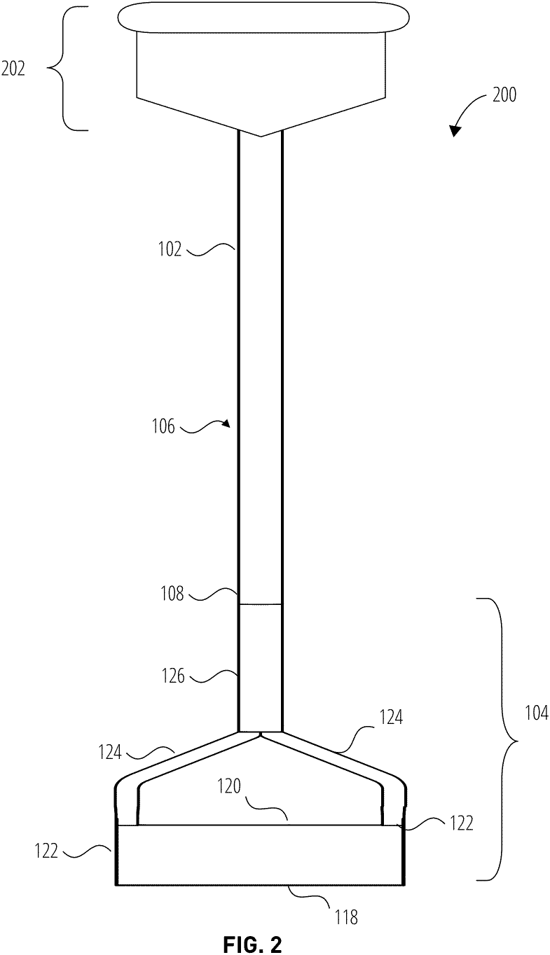

FIG. 2 illustrates a front view 200 of an animal feces collection device according to one embodiment of the invention.

This front view 200 shows the relative dimensions of an embodiment of the invention. In this embodiment, the shovel 116 portion of the device is essentially rectangular.

In this embodiment of the invention, a handle 202 is located at the upper end 102 of the shaft 106.

In operation, the shovel 116 portion of the device is positioned behind the animal feces, with the planar member essentially parallel to the ground. The shovel 116 portion of the head portion 104 is guided towards and beneath the animal feces.

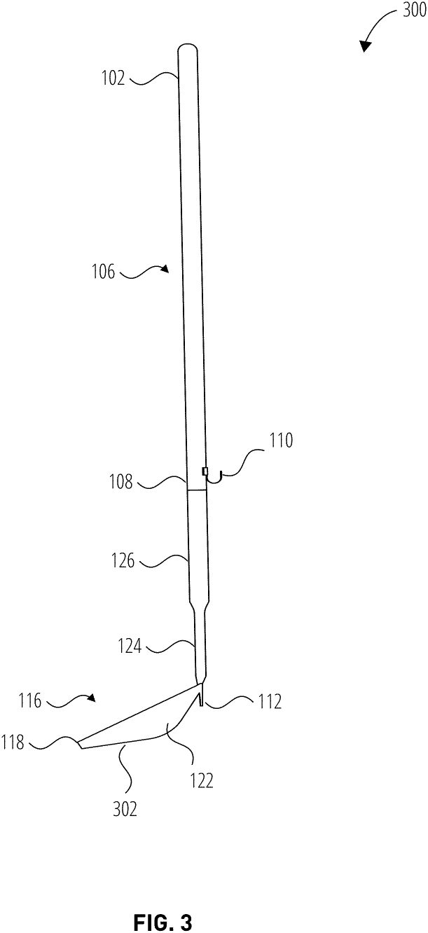

FIG. 3 illustrates a side view 300 of an animal feces collection device according to one embodiment of the invention.

This side view 300 shows an example of the angle between the shovel 116 and the shaft 106 of the device. In the illustrated embodiment of the invention, the angle between the lower surface 302 of the planar member of the shovel 116 and the shaft 106 of the device is approximately 125 degrees. It is contemplated that various different angles would function in the way intended in the range from 90° - 140° Preferred embodiments would include an angle of approximately 125°. Other angles that provide a functional result include 100°, 110°, 120°, and 130°.

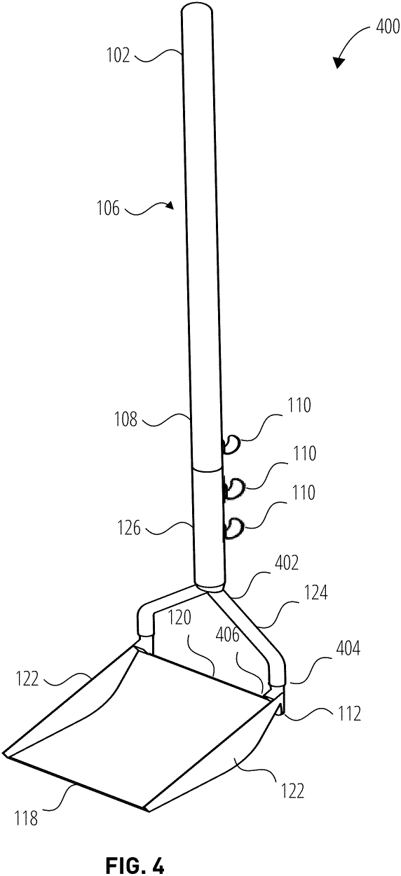

FIG. 4 illustrates a side perspective view 400 of an animal waste/feces collection device according to one embodiment of the invention.

This embodiment of the invention illustrates a device having three points of attachment or first hooks 110. Two of the points of attachment or first hooks 110 are positioned on the connector assembly, shown here as a tubular connector 126, and one of the points of attachment or first hooks 110 is located on the lower end 108 of the shaft 106.

In this embodiment, the shovel 116 part of the head portion 104 is attached to the connector assembly, shown here as a tubular connector 126 via two fork connectors 124. The first end 402 of each fork connector 124 is adapted to be attached to the connector assembly. The shovel 116 part of the head portion 104 is attached to the fork connectors 124 towards the second end 404 of the fork connectors 124. In the illustrated embodiment, the second ends 404 of the fork connectors 124 extends beyond the lower surface 302 of the shovel 116, thereby forming points of attachment, or a second hook 112 and a third hook 114.

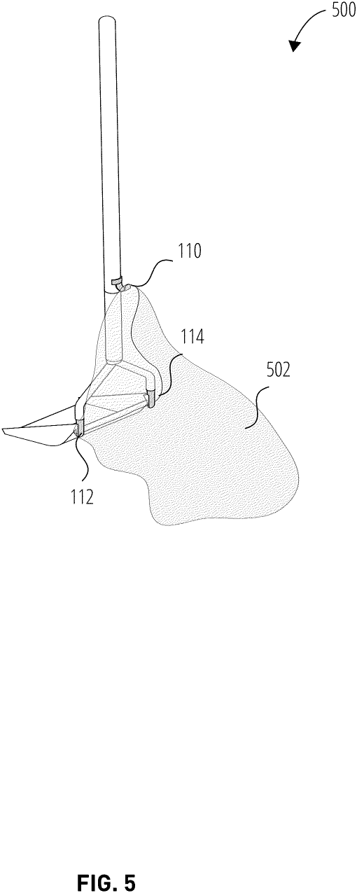

FIG. 5 illustrates a rear perspective view with collection bag attached 500 of an animal feces collection device according to one embodiment of the invention.

This embodiment of the invention illustrates the positioning and attachment of a collection bag 502 affixed to the device at the three points of attachment, namely the first hook 110, the second hook 112 and the third hook 114.

In one embodiment of the invention, a plastic grocery bag is used as the collection bag 502. In the illustrated embodiment of the invention, the device is sized and proportioned such that one handle of the plastic grocery bag can be attached to, and extend between, the second hook 112 and the third hook 114. The other handle of the grocery bag is then attached to the first hook 110.

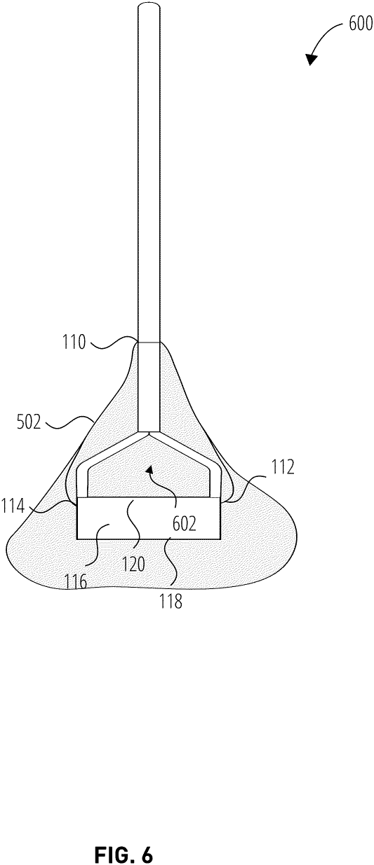

FIG. 6 illustrates a front view with collection bag attached 600 of an animal feces collection device according to one embodiment of the invention.

This view of the device shows the positioning of the opening of the collection bag 502 in relation to the head portion 104 of the device and the lower end 108 of the shaft 106. The dimensions of the collection bag 502 are such that a tight connection is formed between the first hook 110, the second hook 112 and the third hook 114 (collectively the points of attachment).

When positioned as described above, the opening of the bag is held in close proximity to the waste funnel section 602 of the head portion 104 of the device. The waste funnel section 602 is the void created between the rear edge 120 of the shovel 116 and the fork connectors 124.

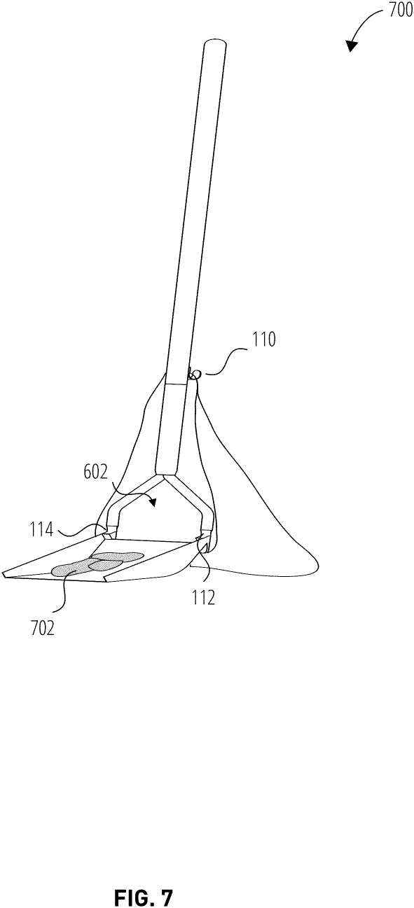

FIG. 7 illustrates a front perspective view with collection bag attached 700 of an animal feces collection device according to one embodiment of the invention.

This view of the illustrated embodiment of the invention shows how the feces 702 pass from the front edge 118 of the shovel 116, over the planar member and over the rear edge 120 of the shovel 116 and through the waste funnel section 602 into the collection bag 502.

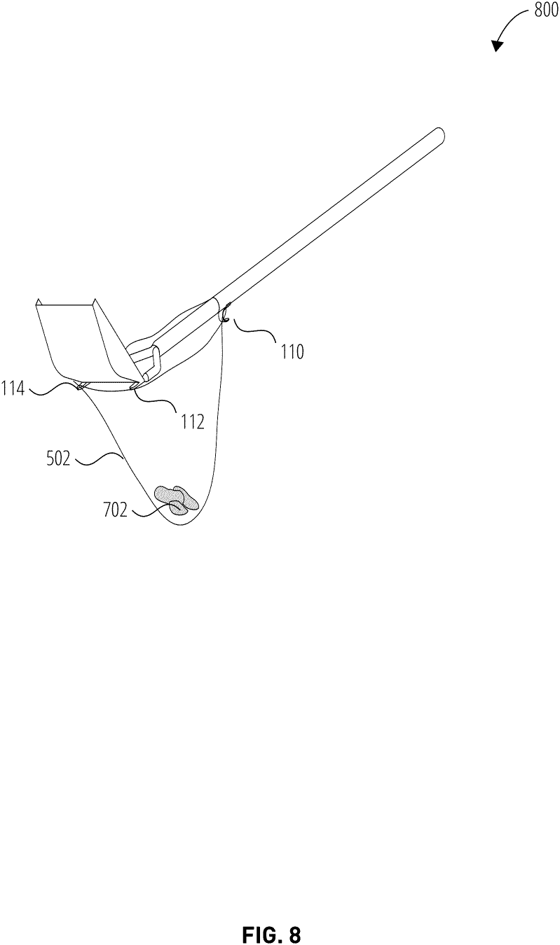

FIG. 8 illustrates an elevated side perspective view with collection bag attached 800 of an animal feces collection device according to one embodiment of the invention.

This figure shows the secure engagement of the collection bag 502 to the device via the points of attachment. The device therefore being able to be repeatedly used to collect additional feces 702.

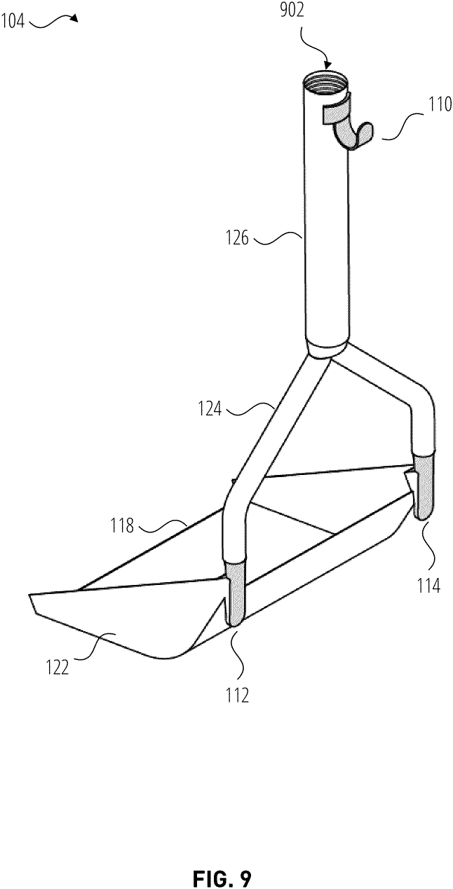

FIG. 9 illustrates a rear perspective view of the head portion 104 of the device.

This particular view of the head portion 104 shows an embodiment having an internal threaded section 902 at the upper end of the tubular connector 126. This embodiment allows the head portion 104 to be purchased separately from the shaft 106. Preferred embodiments of the tubular connector 126 would be sized and configured such that the internal threaded section 902 of the tubular connector 126 would cooperate with standard sized broom handles.

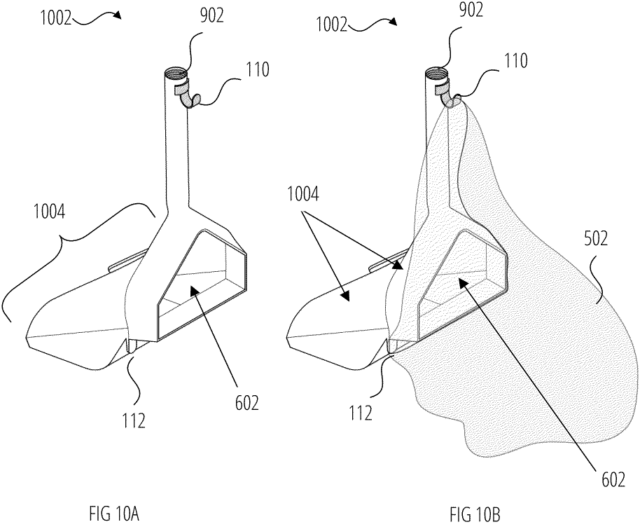

FIGS. 10A and B illustrate rear perspective views of an alternative head portion 1002 of an embodiment of the invention.

FIG. 10A shows a single piece or unitary alternative head portion 1002 that is typically manufactured from a hardened plastic, either via molding, extruding, or 3D-printing techniques known to those of skill in the field.

In this particular embodiment, the sides 122 and fork connectors 124 (illustrated in FIGS. 1-9) are connected to form a unitary combined side and fork member 1004. The sides of the combined side and fork member 1004 are extended vertically upwards to prevent the waste falling over the edges of the sides. In some embodiments of the invention, the rear portion of the combined side and fork member 1004 extends in a rear direction to form and extended waste funnel section 602. The positioning of the first hook 110, second hook 112 and third hook 114 (not shown) may be similarly molded in the same positions as previously described.

FIG. 10B shows the attachment of a collection bag 502 to the alternative head portion 1002 as described above. The collection bag 502 is shown attached to a first hook 110, second hook 112 and third hook 114 (not shown).

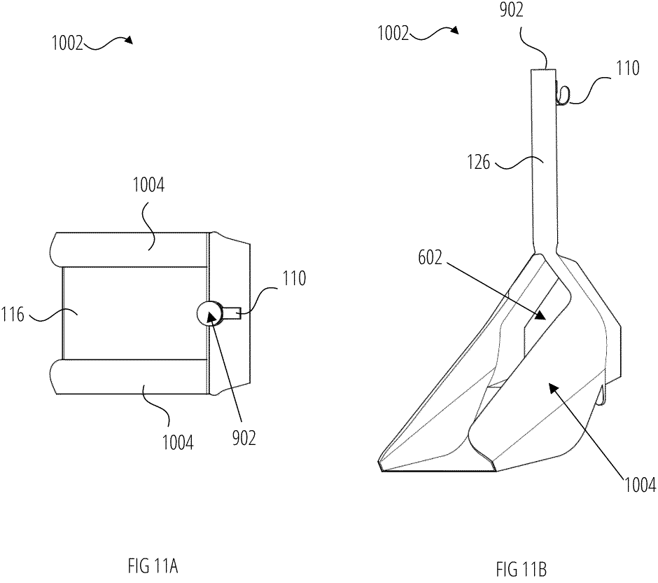

FIGS. 11A and B illustrate top and front side perspective views of an embodiment of an alternative head portion 1002.

FIG. 11A shows the relative configuration of an alternative head portion 1002 having a rectangular shovel 116 portion. The first hook 110 can be seen extending in a rearward direction from the tubular connector 126, the tubular connector 126 having an internal threaded section 902.

FIG. 11B shows the combined side and fork member 1004 extending up, connecting to the tubular connector 126 and forming a waste funnel section 602.

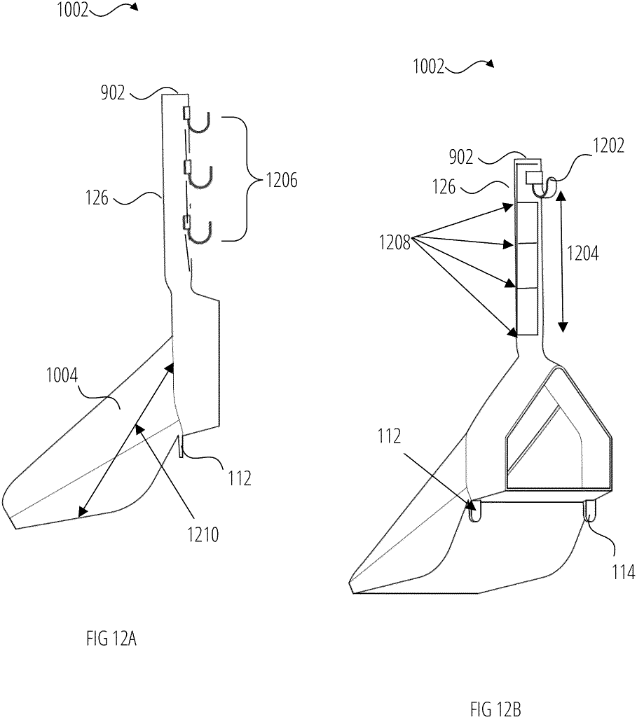

FIGS. 12A and B illustrate side and rear side perspective views of an alternative head portion 1002 in accordance with an embodiment of the invention.

FIG. 12A shows a unitary alternative head portion 1002 having a series of multiple first hooks 1206 affixed to the tubular connector 126. The angle of tilt 1210 of the shovel 116 in relation to the shaft 106 of the device can vary typically from 90-degrees to 135-degrees. A preferred embodiment has the angle of tilt 1210 at 125-degrees.

FIG. 12B shows an alternative head portion 1002 having a single movable first hook 1202 that is configured to slide up and down the tubular connector 126 in the direction of movement 1204 as indicated. In one embodiment of the invention, it is contemplated that a series of grooves and cooperating channels are molded into the body of the tubular connector 126 and movable first hook 1202 to allow the sliding direction of movement 1204. Typically, a series of fixed stop points 1208 is formed on the tubular connector 126 to cooperated with and secure the movable first hook 1202 into the appropriate position to stretch the collection bag 502 into a taut connection with the second hook 112 and third hook 114.

In one embodiment, the tool or device may comprise a handle attached at first end of a shaft and a collection member at a second end of the shaft. The collection member comprises a shovel head having two hooks at the rear of the shovel as well as another hook positioned on the shaft. At the rear of the shovel there is a waste container, such as a collection bag. The pet waste is collected on the head of the shovel, the shovel is then rotated vertically such that the waste slides off the rear of the shovel into the waste container such that the user is able to collect and package the waste from a standing position without having to touch the waste directly. Once the user deems the waste container is full or they wish to dispose of the waste the user rotates the tool such that it is upright and unhooks the waste container from the collection member and shovel head and disposes of it.

It is contemplated that various other waste containers could function to attach to the device. In one embodiment of the invention, standard sized grocery bag can be used. For smaller versions of the device, suitable for miniature breeds of dog, standard dog poop bags can be used.

Collection Bags 502 and containers can be fabricated from numerous different materials including, but not limited to: acrylic or polymethyl methacrylate (PMMA); polycarbonate (PC); polyethylene (PE); polypropylene (PP); polyethylene terephthalate (PETE or PET); polyvinyl chloride (PVC); and acrylonitrile-Butadiene-Styrene (ABS).

Alternative embodiments of the invention include the use of collection bags 502 that are made from compostable or biodegradable plastics including oxo-biodegradable or hydro-biodegradable plastics. Other biodegradable plastics include, but are not limited to: starch-based plastics; bacteria-based plastics; soy-based plastics; cellulose-based plastics; lignin-based plastics and natural fibers.

The head portion 104 of the device can be made from common components known to those of skill in the field. Components may be selected from the group including, but not limited to: steel, stainless steel and aluminum. These embodiments the connector assembly 128 may comprise a metal connector sized and proportioned to attach to the lower end 108 of the shaft 106, and to the elongated members that extend to the shovel. The elongated members may be brackets that are welded or bolted to the connector. The elongated members may also be a unitary forked member that is welded or bolted to the connector. Alternatively, the elongated members can be in the shape of a single semi-circular member.

The elongated members, that can be selected from the group including, but not limited to: brackets; fork connectors 124 or semi-circular members. As described above, the elongated member or members are attached at a first end 402 to the connector, typically a tubular connector 126, by welding or bolting. In one embodiment a bolt extends through the tubular connector 126, through lower end 108 of the shaft 106 that is within the tubular connector 126. First ends 402 of the brackets or fork connectors 124 are attached to either side of the shaft 106 by the bolt and nut mechanism.

The elongated member, comprising brackets, or fork connector 124 or fork connectors 124 are then attached to the sides 122 or rear edge 120 of the shovel 116. Typically, the second end 404 of the elongated member forms one or more points of attachment for the collection bag 502. Hence the shovel 116 is attached to a region on the elongated member that is in the vicinity of the second end 404, but not at the extreme end of the member. Again, the attachment, of the shovel 116 to the elongated member, may be by welding or bolting.

The head portion 104 of the device may also be made from various plastics selected from the group including, but not limited to: Lexan™; Nylon™; acrylics; polycarbonates; polyoxymethylene; polystyrene (HIPS); PP; ABS; and PE.

The plastics may be 3D printed, injection molded or extruded.

Examples of 3D printable plastics include, but are not limited to: polylactic acid, or PLA, this material has the benefit of being biodegradable as it is manufactured using renewable raw materials such as corn starch. ABS filament another type of 3D printing thermoplastic which contains a base of elastomers based on polybutadiene, making it more flexible, and resistant to shocks. ASA is a material that has similar properties to ABS, but has a greater resistance to UV rays. Polyethylene terephthalate, or PET, is ideal for fabricating larger more rigid frames. PETG, is a glycolyzed PET polymer that combines both the simplicity of PLA 3D printing and the strength of ABS, and it is 100% recyclable. Numerous other 3D printable polymers, hybrids and composites are known and considered to be within the scope of protection sought along with combinations thereof.

Plastics that are particularly suitable for injection molding include, but are not limited to: Lexan™ ; Nylon ™ ; acrylics, which are particularly suitable for being tinted; polycarbonate (PC); polyoxymethylene (POM); polystyrene (PS); acrylonitrile butadiene styrene (ABS); polypropylene (PP); polyethylene (PE); thermoplastic polyurethane (TPU); and thermoplastic rubber (TPR) or combinations thereof.

Plastics that are particularly suitable for extrusion include but are not limited to: polyethylene (PE); polypropylene; acetal; acrylic; Nylon™; polyamides; polyvinyl chloride (PVC); acrylonitrile butadiene styrene (ABS); and polycarbonate or combinations thereof.

The shaft 106, and handle 202 when present, may be made from a weather resistant material, including treated wood, metal or plastics. For example, but not limited to: machined pine; steel; stainless steel; aluminum; plastics; natural rubber (Isoprene); styrene-butadiene rubber (SBR); butyl rubber (IIR); nitrile (also known as NBR rubber and Buna-N); Neoprene® (CR); Ethylene Propylene Diene Monomer (EPDM); silicone; Viton® (FKM); polyurethane (AU); and hydrogenated nitrile rubber (HNBR) or combinations thereof.

In other embodiments of the invention, the connection of the shovel 116 via the connector assembly to the tubular connector 126 is via a semi-circular member. The central portion of the semi-circular member being adapted to connect to the tubular connector 126, and either end of the semi-circular member being affixed to the shovel 116.

In some embodiments of the invention, the sides 122 of the shovel 116 extend upwards and are partially curved up and along the semi-circular or fork connectors 124. In this embodiment of the invention, a partially cylindrical waste funnel section 602 is formed to aid with collection.

As described herein, the device allows for the user to collect the waste from a standing position. The ergonomic collection tool or device combines with a waste container or bag in one convenient tool.

The head of the shovel should bevel toward the collection member, bag, or waste container, like a trough. The edges of the shovel must be higher as well to ensure that the waste remains on the shovel head. Once the waste in the waste container accumulates, tension in coupling for the waste container to the hooks further secures the waste container to the collection member and shovel head. The shovel head is flat as opposed to round to help the nose of the shovel to be optimally positioned under the waste.

The tool may be used for any livestock (smaller animals). For property maintenance, collecting debris such as twigs and toys that have been chewed by pets. Various different sized models can be made to suit the specific application. Potentially smaller models for miniature breeds. There are no moving parts. Assembly and disassembly is rapid. It is easy to clean using a hose, as there are no small parts that can corrode or rust.

The foregoing descriptions of specific embodiments of the present invention have been presented for purposes of illustration and description. They are not intended to be exhaustive or to limit the invention and method of use to the precise forms disclosed. Obviously, many modifications and variations are possible in light of the above teaching. As can be understood, the examples described above are intended to be exemplary only.

The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient but is intended to cover the application or implementation without departing from the spirit or scope of the claims of the present invention.

The term “connected”, “attached”, “affixed” or “coupled to” may include both direct coupling (in which two elements that are coupled to each other contact each other) and indirect coupling (in which at least one additional element is located between the two elements).

What is claimed is:

1. An animal waste collection device comprising:
a planar shovel member extending towards a front side of the device, the shovel member having a front edge, a rear edge and two opposing sides;
a tubular connector having a lower end and an upper end;
a connector assembly comprising a fork connector having opposing pronged ends and a central portion, the opposing pronged ends attached to the rear edge or the two opposing sides of the shovel member, the central portion being attached to the lower end of the tubular connector;
a waste funnel section formed between the rear edge of the shovel member and the fork connector;
three or more points of attachment situated at three or more positions around the waste funnel section on a rear side of the device,
wherein a waste collection container is attached to the device via the three or more points of attachment.

2. The animal waste collection device of claim 1, wherein the three or more points of attachment are hooks.

3. The animal waste collection device of claim 1, wherein two of the three or more points of attachment are positioned on the opposing pronged ends of the fork connector.

4. The animal waste collection device of claim 1, wherein one or more of the three or more points of attachment are positioned on the tubular connector.

5. The animal waste collection device of claim 1, wherein one of the three or more points of attachment is slidably attached to the tubular connector.

6. The animal waste collection device of claim 1, wherein the device is made from one or more metals.

7. The animal waste collection device of claim 6, wherein the one or more metals are selected from the group consisting of steel, stainless steel, galvanized steel and aluminum.

8. The animal waste collection device of claim 1, further comprising a shaft having an upper end and a lower end, the lower end of the shaft being connected to the upper end of the tubular connector.

9. The animal waste collection device of claim 8, wherein the lower end of the shaft and the upper end of the tubular connector are connected via one or more bolts or screws.

10. The animal waste collection device of claim 8, wherein the lower end of the shaft has an externally threaded section and the upper end of the tubular connector has a cooperating internally threaded section.

11. The animal waste collection device of claim 8, further comprising a handle attached to the upper end of the shaft.

12. The animal waste collection device of claim 8, wherein one or more of the three or more points of attachment are positioned on the lower end of the shaft.

13. The animal waste collection device of claim 8, wherein one of the three or more points of attachment is slidably attached to the lower end of the shaft.

14. The animal waste collection device of claim 1, wherein the upper end of the tubular connector has an internally threaded section.

15. The animal waste collection device of claim 14, wherein the device is a unitary assembly.

16. The animal waste collection device of claim 15, wherein the device is made from molded, extruded or 3D printed plastic.

17. The animal waste collection device of claim 16, wherein the plastic is selected from the group consisting of: Lexan™; Nylon ™; acrylics; polyamides; polycarbonates; polyoxymethylene; polystyrene; polypropylene; polyethylene terephthalate; polyvinyl chloride; polyethylene glycol; acrylonitrile styrene; ABS; polyethylene; polylactic acid; acrylonitrile butadiene styrene; thermoplastic polyurethane; and thermoplastic rubber and combinations thereof.

18. The animal waste collection device of claim 1, further comprising a shaft connected to the upper end of the tubular connector.
